(19) United States
(12) Patent Application Publication
(10) Pub. No.: US 2013/0119954 A1
(43) Pub. Date: May 16, 2013

(54) ADAPTIVE TRANSIENT LOAD SWITCHING FOR A LOW-DROPOUT REGULATOR

(71) Applicant: iWatt Inc., Campbell, CA (US)

(72) Inventor: Ping Lo, Campbell, CA (US)

(73) Assignee: IWATT INC., Campbell, CA (US)

(21) Appl. No.: 13/676,049

(22) Filed: Nov. 13, 2012

Related U.S. Application Data
(60) Provisional application No. 61/560,769, filed on Nov. 16, 2011.

(51) Int. Cl. G05F 1/10

(52) U.S. Cl. CPC G05F 1/10
USPC 323/280

(57) ABSTRACT

A low-dropout (LDO) voltage regulator includes a switch to generate an output current, and a first sensing module that increases the speed at which the switch is turned off and the output current is decreased in response to detecting a decreasing load current. The LDO regulator further includes a second sensing module that increases the speed at which the switch is turned on and the output current is increased in response to detecting an increasing load current.

### CROSS REFERENCE TO RELATED APPLICATION

This application claims priority under 35 U.S.C. §119(e) from co-pending U.S. Provisional Patent Application No. 61/560,769, filed on Nov. 16, 2011, which is incorporated by reference herein in its entirety.

### BACKGROUND

1. Technical Field

The present disclosure relates to a low-dropout (LDO) regulator, and more specifically relates to LDO regulator output switching.

2. Description of the Related Arts

Fueled by the growth of feature-rich portable electronic devices, demand for more efficient low-voltage regulator devices continues to grow. To help regulate voltages within portable electronic devices, designers often use LDO regulators. LDO regulators generally operate at a lower minimum operating voltage and low quiescent current compared to other types of voltage regulators. But as the load demands of portable electronic devices increase, LDO regulators strain to adequately regulate low voltage output during conditions of high frequency, heavy load switching.

### SUMMARY

Embodiments include an LDO regulator having a switch configured to generate an output current, and a first sensing module that is configured to increase the speed at which the switch is turned off and the output current is decreased in response to detecting a decreasing load current. In other embodiments, the LDO regulator further includes a second sensing module that is configured to increase the speed at which the switch is turned on and the output current is increased in response to detecting an increasing load current.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present disclosure can be readily understood by considering the following detailed description in conjunction with the accompanying drawings.

FIG. 1 is a circuit diagram illustrating an exemplary low-dropout voltage regulator, according to one embodiment.

FIG. 2 is a circuit diagram illustrating an exemplary high-to-low load current sensing module of the low-dropout regulator of FIG. 1, according to one embodiment.

FIG. 3 is a circuit diagram illustrating an exemplary low-to-high load current sensing module of the low-dropout regulator of FIG. 1, according to one embodiment.

### DETAILED DESCRIPTION OF EMBODIMENTS

The Figures (FIGS.) and the following description relate to preferred embodiments of the present disclosure by way of illustration only. It should be noted that from the following discussion, alternative embodiments of the structures and methods disclosed herein will be readily recognized as viable alternatives that may be employed without departing from the principles of the present disclosure.

Reference will now be made in detail to several embodiments of the present disclosure, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the embodiments described herein.

### Exemplary Low-Dropout Regulator Circuit

An LDO regulator operates as a voltage regulator that produces a regulated output voltage even when the unregulated input voltage from a power source drops to a level very near the regulated output voltage. The difference between the input voltage and the output voltage of the regulator is called the “dropout voltage.” Accordingly, when the output voltage of a power supply drops below the regulated output voltage plus the dropout voltage, the voltage regulator fails to produce a regulated output. In other words, the power supply falls out of regulation. For low voltage applications, an LDO regulator provides the advantage of a low-dropout voltage (e.g., 10 mV-500 mV), compared to other types of voltage regulators that have dropout voltages that often exceed 2 V.

The LDO regulator operates to maintain an output voltage within a specified range, in response to varying current demands of the load(s) coupled to the output of the LDO regulator. To serve increased current demands, some LDO regulators use larger pass elements (i.e., metal-oxide field-effect transistor (MOSFET)) to increase the LDO regulator output current, and thus maintain the LDO regulator output voltage within the specified range under maximum load conditions. But as the MOSFET size increases, so does the MOSFET parasitic capacitance, which includes the MOSFET gate capacitance and the Miller capacitance. The increased MOSFET parasitic capacitance, in turn, reduces the response time by which the LDO regulator adapts to the changing load conditions.

LDO regulator 100 addresses the response time deficiencies found in other LDO regulators by increasing the speed at which the MOSFET (M1) parasitic capacitance is charged and discharged. Specifically, LDO regulator 100 creates a charge path to increase the speed at which the voltage across the MOSFET parasitic capacitance is increased in response to sensing a high-to-low transition of the load current. On the other hand, upon sensing a low-to-high transition of the load current, LDO regulator 100 creates a discharge path to increase the speed at which the voltage of the MOSFET parasitic capacitance is decreased.

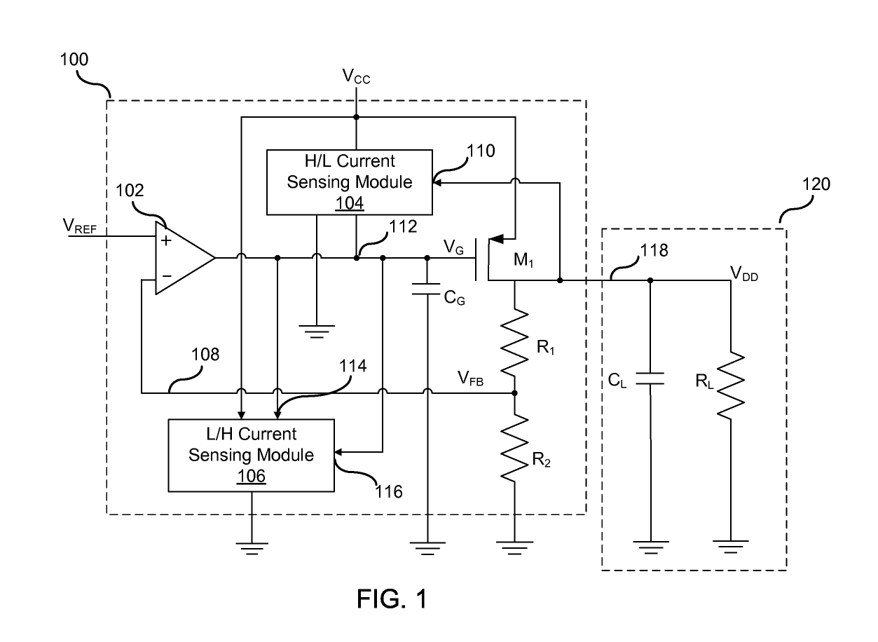

FIG. 1 is a circuit diagram illustrating an exemplary LDO regulator 100, according to one embodiment. The LDO regulator 100 receives an unregulated voltage V_{CC} and generates a regulated output voltage V_{DD} across resistive load R_{L} of load 120. LDO regulator 100 includes error amplifier 102, feedback path 108, P-channel MOSFET M₁, a voltage divider formed by resistor R₁ and R₂, high-to-low (H/L) load current sensing module 104, and low-to-high (L/H) load current sensing module 106. The MOSFET M1 has a variety of types of parasitic capacitances, which are represented collectively as parasitic capacitance C_{G}.

Error amplifier 102 provides an output voltage that represents a difference between the voltages received at its inputs. Error amplifier 102 has a first, positive input coupled to receive a reference voltage V_{REF}, a second, negative input coupled to receive the feedback voltage V_{FB} (through feedback path 108) at the node between resistors R₁ and R₂, and an output coupled to the gate of MOSFET M₁. Reference voltage V_{REF} may be any voltage reference suitable to provide a stable input voltage to error amplifier 102, such as bandgap voltage reference. The feedback voltage V_{FB} is a scaled version of the LDO regulator 100 output voltage V_{DD} obtained from the voltage divider formed by resistors R₁ and R₂.

MOSFET M₁ operates as a common drain amplifier, configured to amplify the output voltage received from error amplifier 102 to generate LDO regulator 100 output voltage V_{DD} across load resistor R_{L}, which tracks the reference voltage V_{REF}. The gate of MOSFET M₁ is coupled to receive the output of error amplifier 102. MOSFET M₁ has a parasitic capacitor C_{G} coupled between the input of MOSFET M₁ and ground. MOSFET parasitic capacitor C_{G} represents the sum of the gate capacitance and Miller capacitance of MOSFET M₁. The gate of MOSFET M₁ is further coupled to the input 114 of L/H load current sensing module 106. The source of MOSFET M₁ is coupled to unregulated power supply V_{CC}, and the drain of MOSFET M₁ is coupled to the resistor R₁ of the voltage divider formed by R₁ and R₂. The drain of MOSFET M₁ is further coupled to the input 110 of H/L load current sensing module 104 and load 120 through output path 118. It is to be noted that the P-channel MOSFET M₁ can be substituted with an N-channel MOSFET with proper adjustments to other parts of the circuit. In other embodiments, the P-Channel MOSFET M₁ can be substituted with a bipolar junction transistor (BJT) with proper adjustments to other parts of the circuit.

Load 120 may be modeled as a resistive-capacitive (RC) load that includes a resistive element resistor R_{L} and a capacitive element C_{L}. It is to be noted that load 120 may include other passive or active circuit components not shown in FIG. 1. Load 120, although depicted as a single load, may be more than one load. For example, load 120 may be a variety of integrated circuit (IC) chips within a portable electronic device, such as a digital-to-analog converter, analog-to-digital converter, processor, transceiver, display driver, and user interface IC. LDO regulator 100 may be coupled to one or more of these IC chips (loads 120), each IC chip having varying current requirements during the operation of the device. Accordingly, reference to load 120 within this disclosure may refer to one or multiple loads unless otherwise specified.

Varying current demands of load 120 generate fluctuations in LDO regulator 100 output voltage V_{DD}. And in cases where the load current quickly transitions from a low-to-high or from high-to-low, LDO regulator 100 senses the variations in the load current and adaptively increases the response time of LDO regulator 100 to meet these changing load current conditions.

In the first case, the load current through R_{L}, transitions from a high current state to a low current state. This condition may occur, for example, when a portable electronic device load is put into a low-power mode by turning off the display and reducing system clock speed. In response to the reduced load current, LDO regulator 100 output voltage V_{DD} decreases, causing feedback voltage V_{FB} to track the decreased output voltage. Error amplifier 102 then outputs an error voltage signal to increase the gate voltage V_{G} to turn off MOSFET M₁ to reduce the current output from LDO regulator 100 to accommodate the decrease in load current. To increase the speed by which MOSFET M₁ turns off, H/L load current sensing module 104 detects the high-to-low transition of the load current in the output path 118, and increases the current applied to MOSFET M₁ parasitic capacitor C_{G}, causing the gate voltage V_{G} to become more positive at a greater speed than it would without the H/L current sensing module 104. As the gate voltage V_{G} becomes more positive more rapidly, the rate at which MOSFET M₁ turns off increases, causing a corresponding increase in the rate by which LDO regulator 100 reduces the load current supplied to load 120 through output path 118, thereby making the high-to-low transition of the load current smoother.

In the second case, the load current through R_{L}, transitions from a low current state to a high current state. This condition may occur, for example, when a portable electronic device load wakes up from a low-power mode to a normal operation mode, or when the device turns on a radio for wireless communications. In response to the increased load current, LDO regulator 100 output voltage V_{DD} increases, causing feedback voltage V_{FB} to track the increased output voltage. Error amplifier 102 then outputs an error voltage signal to decrease the gate voltage V_{G} to turn on MOSFET M₁ to increase the current output from LDO regulator 100 to accommodate the increased load current. To increase the speed by which MOSFET M₁ turns on, L/H load current sensing module 106 detects the low-to-high transition of the load current in the output path 118 by sensing the corresponding change in the output current of error amplifier 102 at MOSFET parasitic capacitor C_{G}. L/H load current sensing module 106 then creates a discharge path from the gate node of MOSFET M₁ to input 114 of L/H load current sensing module 106, causing the gate voltage V_{G} to become more negative at a greater speed. As the gate voltage V_{G} becomes more negative, the rate at which MOSFET M₁ turns on increases, causing a corresponding increase in the rate by which LDO regulator 100 increases the load current supplied to load 120 through output path 118, thereby making the low-to-high transition of the load current smoother.

### Exemplary High-to-Low Load Current Sensing Module

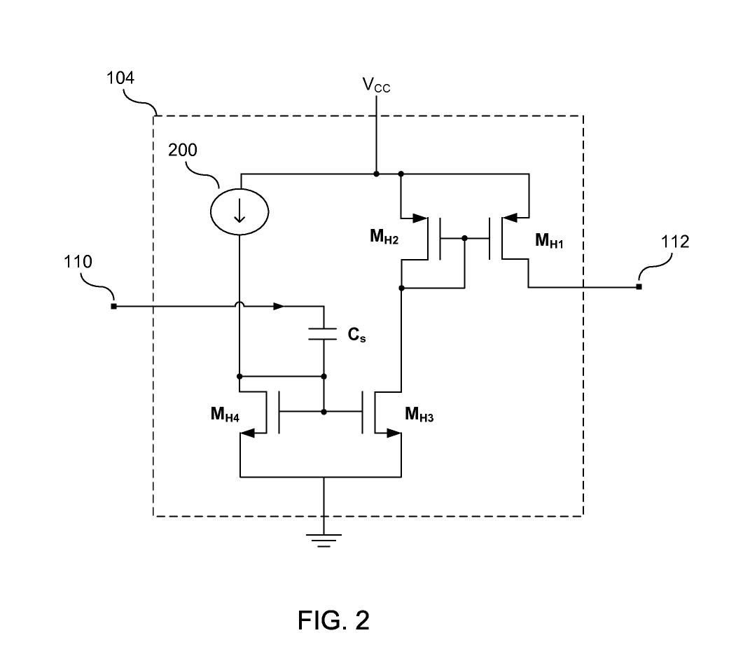

FIG. 2 is a circuit diagram illustrating an exemplary high-to-low (H/L) load current sensing module 104 of the low-dropout regulator 100, according to one embodiment. Nodes 110 and 112 in FIG. 2 correspond to the same nodes 110 and 112 in FIG. 1. As previously described in conjunction with FIG. 1, H/L load current sensing module 104 operates to increase the speed by which MOSFET M₁ turns off when the load current transitions from high-to-low, by creating a charge path to increase the voltage across MOSFET parasitic capacitor C_{G} more rapidly, causing the gate voltage V_{G} to become more positive relative to the source of MOSFET M₁ more rapidly. H/L load current sensing module 104 includes a current source 200, and a pair of current mirrors formed by MOSFETs M_{H1} and M_{H2}, and MOSFETs M_{H3} and M_{H4}. Current source 200 acts a current reference for the current mirror formed by MOSFETs M_{H3} and M_{H4}. This reference current is copied to the drain of MOSFET M_{H2} and MOSFET M_{H3}, which acts as reference current for the current mirror formed by MOSFETs Mᵢₙ and M_{H2}. This copied reference current is then copied to the drain of MOSFET M_{1H}, which is then used to charge MOSFET M₁ parasitic capacitor C_{G} at node 112.

Current source 200 is coupled to supply voltage V_{CC} and the drain of MOSFET M_{H4}. The drain of MOSFET M_{H4} is further coupled to the gate of MOSFET M_{H4}, capacitor C_{S}, and the gate of MOSFET M_{H3}. The source of MOSFET M_{H4} is coupled to ground. The source of MOSFET M_{H3} is also coupled to ground, and its drain is coupled to the drain and gate of MOSFET M_{H2}. The source of MOSFET M_{H2} is coupled to supply voltage V_{CC}, and the gate of MOSFET M_{H2} is coupled to the gate of MOSFET M_{H1}. The source of MOSFET Mᵢₙ is coupled to supply voltage V_{CC}, and the drain of MOSFET M_{H1} is coupled to MOSFET M₁ parasitic capacitor C_{G}.

The load current output path 118 in FIG. 1 is coupled to node 110. Thus, in response to reduced load current on the output path 118, the voltage at node 110 is reduced, capacitor C_{S} discharges, causing the MOSFET M_{H4} to turn on, which turns on the current mirror formed by MOSFETs M_{H4} and M_{H3}. The reference current supplied by current source 200 is then copied to the drain of MOSFET Mᵢₙ as previously described. The reference current supplied by current 200 is used to charge MOSFET M₁ parasitic capacitor C_{G} at node 112, which is coupled to the drain of MOSFET M₁. Thus, H/L load current sensing module 104 creates a path to quickly charge MOSFET M₁ parasitic capacitor C_{G} to increase the rate at which MOSFET M₁ turns off responsive to a reduction in the load current through output path 118, thereby making the high-to-low transition of the load current smoother.

### Exemplary Low-to-High Load Current Sensing Module

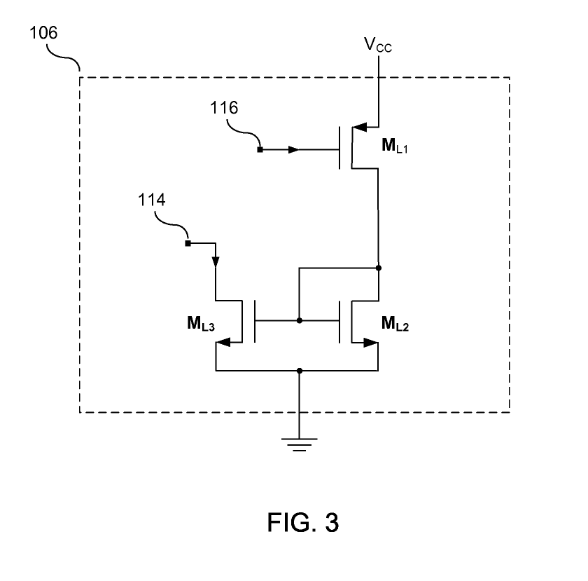

FIG. 3 is a circuit diagram illustrating an exemplary low-to-high (L/H) load current sensing module 106 of the low-dropout regulator 100, according to one embodiment. Nodes 114 and 116 in FIG. 3 correspond to the same nodes 114 and 116 in FIG. 1. As previously described, L/H load current sensing module 106 operates to increase the speed at which MOSFET M₁ turns on when the load current transitions from low-to-high, by creating a discharge path to decrease the voltage across MOSFET M₁ parasitic capacitor C_{G}, causing the gate voltage V_{G} to become more negative relative to the source of MOSFET M₁ more rapidly. L/H load current sensing module 106 includes a current mirror formed by MOSFETs M_{L2} and M_{L3}, and MOSFET M_{LA}. MOSFET M_{IA} has a source coupled to supply voltage V_{CC}, and a gate coupled to sense the voltage at node 116 at the gate of MOSFET M₁ across parasitic capacitor C_{G}. MOSFET M_{L2} has a drain coupled to its gate and further coupled to the drain of MOSFET M_{LA}. The source MOSFET M_{L2} is coupled to ground. MOSFET M_{L3} has a source coupled to ground, a gate coupled to the gate of MOSFET M_{L2}, and a drain coupled to MOSFET M₁ parasitic capacitor C_{G} at node 114 to create a discharging path to decrease the voltage across MOSFET M₁ parasitic capacitor C_{G} more rapidly. In response to an increased load current at the output path 118, error amplifier 102 outputs an error voltage signal to decrease the gate voltage V_{G} to turn on MOSFET M₁ as previously described in conjunction with FIG. 1. The gate voltage V_{G} is coupled to the gate of MOSFET M_{L1} at node 116, and thus the decreased gate voltage V_{G} turns on MOSFET M_{L1}, which turns on the current mirror formed by MOSFETs M_{L2} and M_{L3}. The reference current created by MOSFETs M_{L2} and M_{L2} is copied to the drain of MOSFET M_{L3}. The drain of MOSFET M_{L3} is coupled to MOSFET M₁ parasitic capacitor C_{G} at node 114 to create a discharge path to reduce the voltage across MOSFET M₁ parasitic capacitor C_{G} more rapidly than it would without the L/H current sensing module 106. Thus, L/H load current sensing module 106 creates a path to quickly discharge MOSFET M₁ parasitic capacitor C_{G} to increase the rate at which MOSFET M₁ turns on responsive to an low-to-high transition in the load current through output path 118, thereby making the low-to-high transition of the load current smoother.

Upon reading this disclosure, those of ordinary skill in the art will appreciate still additional alternative structural and functional designs for LDOs that can adapt to rapid changes in the load current through the disclosed principles of the present invention. Thus, while particular embodiments and applications of the present invention have been illustrated and described, it is to be understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A low-dropout (LDO) voltage regulator providing a regulated output voltage across a load from an unregulated voltage source, the LDO voltage regulator comprising:
a feedback path for providing a feedback voltage representing an output current at an output of the LDO voltage regulator;
an error amplifier configured to generate an error voltage signal representing a difference between the feedback voltage and a reference voltage;
a switch configured to receive the error voltage signal and generate the output current of the LDO voltage regulator based on the error voltage;
a first sensing circuit configured to detect a decrease in the output current and, responsive to detecting the decrease in the output current, to increase a speed at which the output current is decreased; and
a second sensing circuit configured to detect an increase in the output current and, responsive to detecting the increase in the output current, to increase a speed at which the output current is increased.

2. The LDO voltage regulator of claim 1, wherein the switch is a P-channel MOSFET and, responsive to detecting the decrease in the output current, the first sensing circuit is configured to further increase a gate voltage of the P-channel MOSFET in addition to increase in the gate voltage caused by the error voltage signal.

3. The LDO voltage regulator of claim 1, wherein the switch is a P-channel MOSFET and, responsive to detecting the increase in the output current, the second sensing circuit is configured to further decrease a gate voltage of the P-channel MOSFET in addition to decrease in the gate voltage caused by the error voltage signal.

4. The LDO voltage regulator of claim 1, wherein the switch is a P-channel MOSFET and the first sensing circuit includes a current mirror configured to be driven by a reference current, and responsive to the first sensing circuit detecting the decrease in the output current, the current mirror is configured to provide the reference current to increase a gate voltage of the P-channel MOSFET.

5. The LDO voltage regulator of claim 1, wherein the switch is a P-channel MOSFET and the second sensing circuit includes a current mirror, and responsive to the second sensing circuit detecting the increase in the output current, the current mirror is configured to provide discharge current to decrease a gate voltage of the P-channel MOSFET.

6. The LDO voltage regulator of claim 1, wherein the first sensing circuit is configured to detect the decrease in the output current by sensing the feedback voltage representing the output.

7. The LDO voltage regulator of claim 1, wherein the second sensing circuit is configured to detect the increase in the output current by sensing a decrease in the error voltage signal.

8. A method of operating a low-dropout (LDO) voltage regulator, the method comprising:
providing a feedback voltage representing an output current at an output of the LDO voltage regulator;
generating an error voltage signal representing a difference between the feedback voltage and a reference voltage;
generating the output current of the LDO voltage regulator based on the error voltage;
responsive to detecting a decrease in the output current, increasing a speed at which the output current is decreased; and
responsive to detecting an increase in the output current, increasing a speed at which the output current is increased.

9. The method of claim 8, wherein the LDO voltage regulator comprises a P-channel MOSFET configured to receive the error voltage signal and generate the output current of the LDO voltage regulator based on the error voltage, the method further comprising:
responsive to detecting the decrease in the output current, further increasing a gate voltage of the P-channel MOSFET in addition to increasing the gate voltage caused by the error voltage signal.

10. The method of claim 8, wherein the LDO voltage regulator comprises a P-channel MOSFET configured to receive the error voltage signal and generate the output current of the LDO voltage regulator based on the error voltage, the method further comprising:
responsive to detecting the increase in the output current, further decreasing the gate voltage of the P-channel MOSFET in addition to decreasing the gate voltage caused by the error voltage signal.

11. The method of claim 8, wherein the LDO voltage regulator comprises a P-channel MOSFET configured to receive the error voltage signal and generate the output current of the LDO voltage regulator based on the error voltage, the method further comprising:
responsive to detecting the decrease in the output current, providing the reference current to increase the gate voltage of the P-channel MOSFET.

12. The method of claim 8, wherein the LDO voltage regulator comprises a P-channel MOSFET configured to receive the error voltage signal and generate the output current of the LDO voltage regulator based on the error voltage and, the method further comprising:
responsive to detecting the increase in the output current, providing discharge current to decrease the gate voltage of the P-channel MOSFET.

13. The method of claim 8, further comprising:
detecting the decrease in the output current by sensing the feedback voltage representing the output.

14. The method of claim 8, further comprising:
detecting the increase in the output current by sensing a decrease in the error voltage signal.
